(19) United States
(12) Patent Application Publication
(10) Pub. No.: US 2009/0303909 A1
(43) Pub. Date: Dec. 10, 2009

(54) POINT-TO-MULTIPOINT DATA COMMUNICATION

(76) Inventors: Iraj Farhoudi, Taby (SE); Krister Sundberg, Sollentuna (SE)

Correspondence Address: NIXON & VANDERHYE, PC, 901 NORTH GLEBE ROAD, 11TH FLOOR, ARLINGTON, VA, 22203, US

(21) Appl. No.: 10/587,025

(22) PCT Filed: Feb. 24, 2004
(86) PCT No.: PCT/SE2004/000249

§ 371 Date: Jul. 16, 2009

(51) Int. Cl. H04H 20/71; H04W 4/10

(52) U.S. Cl. 370/312; 455/422.1

(57) ABSTRACT

A sending user unit (400) provides data, intended to multiple receiving user units (410-430), to a communications server (100). The server (100) identifies a set of at least two receiving user units (410-412; 420-424) that participate in the session and are associated with a same cell (15; 25). The set of user units (410-412; 420-424) are identified based on session identifiers (144) and cell identifiers (146) stored in an associated database (140). The data from the sending user unit (400) is then simultaneously transmitted to the receiving user units (410-412; 420-424) in a point-to multipoint manner using a same dedicated channel specific for the cell (15, 25) in which the user units (410-412; 420-424) of set are present. The invention is in particular applicable to Push to talk over cellular (PoC) and other group-based data communications services.

### TECHNICAL FIELD

The present invention generally relates to data communication, and in particular to point-to-multipoint data communication in cellular communications systems.

### BACKGROUND

A trend in cellular communications systems of today is the emergence of new communications services provided to users. Services traditionally associated with computer networks are now, e.g. by means of the Internet protocol (IP), also available for cellular communications systems. Furthermore, several group-based communications services are being introduced into existing cellular communications system, where a single user simultaneously communicates with several other users. A typical example of such a service is the so-called push to talk services.

Push to talk over Cellular (PoC) is a communications service that basically functions as a “walkie-talkie” service, but implemented in a cellular telecommunications system. A PoC enabled handset or mobile unit is then equipped with a dedicated PoC (hardware or software) button. As for a traditional walkie-talkie, when the button is pressed, the user handset connects directly with the handsets of a particular friend, with whom the user wants to communicate. It is also possible to connect to and communicate with a group of people having access to PoC enabled handsets.

The principle of communication behind the PoC service is very simple, just to push the button and start talking. Since the user typically always has direct access to the service (based on a subscription with a service provider, e.g. the network provider, offering PoC services) without dial-up and other time-consuming procedures, PoC calls can be started directly with a group of users after pressing the button. In other words, the call connection is almost instantaneous.

In the Packet Switched (PS) domain of the cellular communications system, the PoC traffic is carried by a limited number of Packet Data Channels (PDCHs). Since several users, including PoC users, share these channels, the throughput can occasionally be significantly lower than a predefined or guaranteed throughput for a specific user. In addition, it is also possible that the system will run out of PDCHs, e.g. either due to pre-emption by a high priority service such as voice or due to a very high data load, including high PoC data load. When a user experience such a lack of resources, this will appear as delays in the data transfer or even loss of data (audio) bursts. Delays are often acceptable as long as they are kept within specified limits. However, if the delays increase, they will ruin the perceived interactivity when users talk with each other and degrade the user-perceived “real-time feeling”.

Furthermore, in the case where several PoC users are located in the same cell they will compete over the same resources (PDCHs). This means that in some situations either the PoC users will experience reduced performance and interactivity or get poor service just because some other PoC users get more resources.

Thus, there is a problem with limited communications resources for PoC services and other group-based communications services in cellular communications systems.

### SUMMARY

The present invention overcomes these and other drawbacks of the prior art arrangements.

It is a general object of the present invention to provide efficient group-based data communication in cellular communications systems.

It is another object of the invention to provide a group-based data communication that reduces communications resource utilization.

It is a particular object of the invention is to provide point-to-multipoint transmission of communications data originating from a user communications units to other user communications units associated with a same cell.

These and other objects are met by the invention as defined by the accompanying patent claims.

Briefly, the present invention involves group-based data communication where communications data originating from a user communications unit simultaneously is transmitted to multiple other user communications units on a single dedicated channel or communications resource.

According to the invention a sending user communications unit wants to simultaneously communicate with multiple receiving user communications units in a group-based communications session. The sending user unit transmits the communications data intended to the multiple receiving user units to a communications server that manages the group-based data communication. The communications server then identifies a set of at least two receiving communications units that participate in the group-based communications session and are associated with a same cell. The server preferably identifies the communications units of the set from an associated list or database including address information and cell identifiers of the communications units. Once a set of multiple receiving communications units that are present in a same cell and active in a same communications session is identified, the data from the sending user unit is simultaneously transmitted in a point-to-multipoint manner to the identified receiving user communications units of the set. This point-to-multipoint data transmission is realized using a same dedicated channel specific for the cell in which the user units of the set are present. Thus, a single channel or communications resource is used for transmission of user data to multiple user units.

For example, a group-based communications session comprises seven participating user units, where a sending user unit and two receiving user units are associated with a first cell, three receiving user units are situated in a second cell and a single receiving user unit is connected to a third cell. Using prior art techniques, the communications data from the sending user unit would be transmitted to the receiving user communications units by means of six different (downlink) channels. However, according to the present invention, the two receiving user units of the first cell form a first set and a second set includes the three user units of the second cell. The data from the sending mobile unit is then transmitted in a point-to-multipoint manner to the user units of the two sets using only two communications (downlink) channels. The data is also provided in a prior art point-to-point manner using one channel to the receiving user unit in the third cell. Thus, only three different (downlink) channels are required for the data transmission according to the invention in this example compared with six channels for a prior art solution. The benefits of the present invention is particular prominent in situations where many receiving user communications units are present in a same cell.

The communications server of the invention preferably receives the address information and cell identifiers from the communications units that are to participate in the communications session. This transmission of information to the server is preferably conducted when the user units connect or register to the server, e.g. when they are switched on or during the set up of the communications session. Thereafter, the communications server generates a session identifier for the communications units of the session and stores this session identifier together with the cell identifier and address information in an associated database.

The communications server subsequently compares the session identifiers in its associated database and identifies those receiving user communications units that are associated with a given session identifier. The cell identifiers of those receiving user units having the same session identifier, i.e. is participating in a same communications session, are then compared. The communications server identifies any communications units that have a same associated cell identifier, i.e. are connected to a same cell, and groups them into a set or sub-group.

The identified receiving user communications units of a set are then notified information of a dedicated channel they should lock and listen to in order to receive the data originating from the sending user communications unit. If the communications units already are connected to this dedicated (downlink) channel no notification thereof is required. The communications data is then provided to the user units of the set using the notified dedicated communications channel.

The present invention can be applied to different types of data communications within a group of participating user communications units, where a single user communications unit simultaneously wants to transmit data to multiple other user units. For example, the invention can be applied to Push to talk over Cellular (PoC) data communication, video telephony and conferences and different we-share applications.

In particular for the case with a communications system providing PoC services to user communications units, the communications server according to the invention preferably comprises a modified PoC application server that typically handles call set-up signaling for PoC calls and the flow control of PoC traffic. The communications server further preferably comprises or has access to a Multimedia Broadcasting Multicasting Service (MBMS) server that enables simultaneous distribution of data to several users using the same physical Multimedia Receiver Channel (MMRC).

In such a case, the PoC server is preferably equipped with a database storing address information, session identifier and cell identifier for the user communications units participating in a PoC (group-based) communications session. The PoC server further includes functionality for identifying any sets of multiple receiving user units in the session positioned in the same cell, preferably based on the stored cell identifier and session identifier in the database. The PoC server then informs the MBMS server of these receiving user units forming a set and provides the data packets comprising the PoC data from the sending user unit to the MBMS server. This MBMS server then initiates the point-to-multipoint transmission set up and the user units of the set are informed of which downlink channel they (all) should listen and lock to. The MBMS server then simultaneously provides the data packets to the user units of the set using the notified downlink channel.

The invention offers the following advantages:
Reduces communications resource needs and utilization in a communications system;
Reduces the interference in the downlink caused by user communications units participating in a group-based data communications session;
Removes the limit of the maximum number of simultaneous participants in a communications session in one cell;
Enables reduction of transmission delays for user units and increase in Quality of Service;
Increases the usability of group-based data communication, such as push-to-talk, in cellular communications systems; and
Reduces the risk of overloading queues in Packet Control Units (PCUs).

Other advantages offered by the present invention will be appreciated upon reading of the below description of the embodiments of the invention.

### SHORT DESCRIPTION OF THE DRAWINGS

The invention together with further objects and advantages thereof, may best be understood by making reference to the following description taken together with the accompanying drawings, in which:

FIG. 1 is a schematic overview of a communications system according to the present invention providing group-based data communications;

FIG. 2 is a schematic block diagram of a communications server according to the present invention;

FIG. 3 is an illustration of a database of the communications server of FIG. 2;

FIG. 4 is a schematic signal diagram of the data communication method of the present invention;

FIG. 5 is a block diagram illustrating an embodiment of a communications server adapted for Push to talk over Cellular (PoC) data communication according to the present invention;

FIG. 6 is an illustration of a database of a PoC server portion of the communications server of FIG. 5;

FIG. 7 is a block diagram of a set identifier of the PoC server portion of the communications server of FIG. 5;

FIG. 8 is an illustration of a database of a Multimedia Broadcasting Multicasting Service (MBMS) server portion of the communications server of FIG. 5;

FIG. 9 is a flow diagram of the communications method according to the present invention;

FIG. 10 is a flow diagram illustrating additional steps of the communications method of FIG. 9; and

FIG. 11 is a flow diagram illustrating the set identifying step of FIG. 9 in more detail.

### DETAILED DESCRIPTION

Throughout the drawings, the same reference characters will be used for corresponding or similar elements.

The present invention relates to group-based data communications where communications data originating from a user communications unit simultaneously is transmitted to multiple user communications units on a single dedicated channel or communications resource.

The teaching of the present invention discussed and disclosed herein can be applied to several data communication services and types in cellular communications systems including, but not limited to, Push to talk over Cellular (PoC) data communication, video telephony and conferences and different we-share applications. Thus, the present invention is directed to data communications within a group of participating user communications units, where a single user communications unit simultaneously wants to transmit data to all or at least several user units participating in the communications group.

The user communications unit could be any user equipment that is able to conduct data communication with other user equipment over an associated communications system. For example, the user communications unit could be a mobile unit, such as a mobile telephone or laptop connected to a mobile phone, in a cellular communications system or a computer in a Wireless Local Area Network (WLAN) (cellular) communications system.

In the following the invention will be described with reference to a cellular radio communications system providing data communications to a group of associated mobile units. However, the present invention is not limited to this example but could include other communications systems and/or user communications units, e.g. as discussed above.

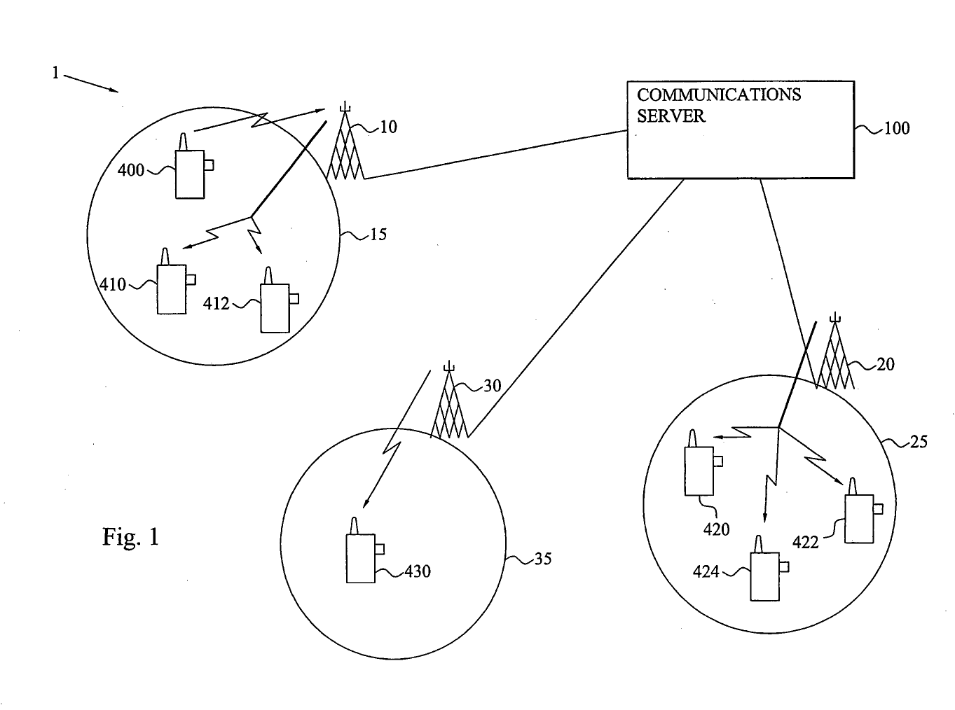

FIG. 1 illustrates a cellular communications system 1 according to the present invention. Only units and elements of the system 1 directly participating in the present invention are explicitly shown in the figure in order to simplify the illustration.

The communications system 1 comprises a number of associated mobile units 400-430 situated in different cells 15, 25, 35 and being members of and participating in a data communications session. Each such cell 15, 25, 35 is associated with and served by a respective base station 10, 20, 30 that is in connection with a communications server 100 managing the data communication between the mobile units 400-430.

During the communications session a mobile unit 400, hereinafter denoted sending mobile unit, wants to (simultaneously) transmit data to several other mobile units 410-430, denoted receiving mobile units. The communication data could be any form of data such as audio, voice, images, video, text, etc. and is preferably transmitted as data packets from the sending mobile unit 400 to the receiving mobile units 410-430 over the communications system 1.

The user of the sending mobile unit 400 typically first selects which receiving mobile units 410-430 that he/she wants to communicate with, i.e. which mobile units that are to participate in the communications session. This selection could be performed by identifying the receiving mobile units 410-430 from an address book or similar user list in the sending mobile unit 400. The data is then generated in the sending mobile unit 400 and transmitted to its associated or connected base station 10. For example, in case of voice, the user of the sending mobile 400 starts to talk and the talk is sampled and packed in data packets that is transmitted to the base station 10. The base station 10 then forwards the communication data (data packets) to the communications server 100.

This server 100 comprises or has access to a list or database comprising information of the mobile units 400-430 participating in the communications session. The database includes an identifier or address information of each mobile unit 400-430, which enables the communications server 100 to correctly identify the mobile units 400-430 and communicate with them, i.e. transmit data thereto. The database also comprises information of the cell 15, 25, 35, with which the mobile units 400-430 currently are connected or associated, which is discussed in more detail below. Based on this cell information, the communications server 100 identifies any set or sub-group of multiple (at least two) receiving mobile units 410-412, 420-424 in the session having the same cell information. In other words, the communications server 100 identifies those receiving mobile units 410-412, 420-424 in the session that are associated with, i.e. belong to, the same cell 15, 25. Thus, the expression a “set of mobile units” refers, according to the invention, to a set or sub-group of multiple, at least two, receiving mobile units that are associated with a same cell and participate in a same communications session. In addition, the mobile units of the set are to receive communications data, originating from a sending mobile unit, over a communications system. In FIG. 1, receiving mobile units 410 and 412 are both connected to the base station 10 and, thus, belong to a same cell 15. Correspondingly, receiving mobile units 420-424 are associated with a same cell 25. Thus, the mobile units 410-412 form a first set of receiving mobile units according to the present invention and the mobile units 420-424 form a second set. Since mobile unit 430 is the only receiving mobile unit of the session situated in cell 35, it does not belong to a set of receiving mobile units according to the present invention.

The communications server 100 then simultaneously provides the data from the sending mobile unit 400 to the identified receiving mobile units 410-424 using a single dedicated channel for each set. With reference to FIG. 1, the data is transmitted to mobile units 410 and 412 using a single (downlink) channel associated with the cell 15, whereas another single channel associated with the cell 25 is used for providing the data to the three mobile units 420-424. This form of data transmission is denoted point-to-multipoint transmission in the art, where data from a single point, i.e. the base station 10, 20 of the respective cell 15, 25, transmits the data to several points, i.e. the mobile units 410-412, 420-424 of the two sets, using a single channel. The data is also provided to the receiving mobile unit 430 that is not part of a set of the invention. However, this form of communication is a so-called point-to-point communication where a single point, base station 30, transmits the data to a single point, the mobile station 430.

It is obvious that point-to-multipoint transmission is preferred in the view of resource utilization since a same channel (communications resource) is used for data transmission to several mobile units instead of one channel per mobile unit as in the prior art point-to-point transmission.

Applying prior art techniques for group-based data communication on the example in FIG. 1 and discussed above, the data from the sending mobile unit 400 would be transmitted to the six receiving mobile units 410-430 using six different downlink channels. However, employing the present invention to the same communications session, only three different channels are required for performing the same data downlink transmission. Thus, the present invention reduces the amount of required channels tremendously, in particular in cases where several receiving mobile units of a session are present in a same cell. This reduction in channel needs frees up significant amount of communications resources that can be employed by the communications system for other types of data communication and/or other group-based communications sessions.

According to the present invention a “dedicated channel” refers to a logical channel or communications resource that at least temporarily is reserved for simultaneously point-to-multipoint transmission of data to several receiving mobile units in a cell. It is anticipated by the invention that this logical channel in turn can comprise one or multiple physical channels or sub-channels. For example, the dedicated channel could be realized as one or several time slots used for providing the data to receiving mobile units of a set.

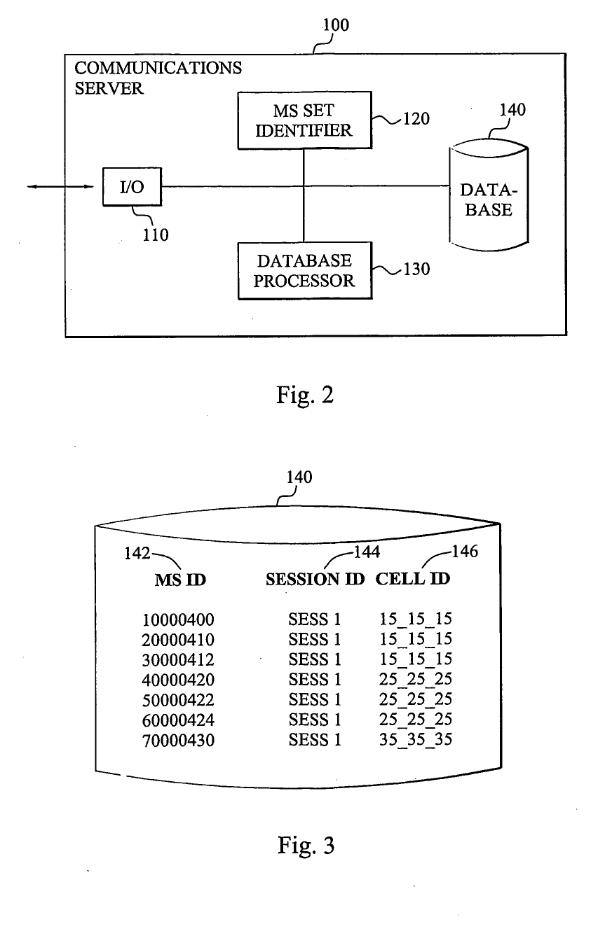

FIG. 2 is a schematic block diagram of the communications server 100 of FIG. 1. The communications server 100 comprises an input and output (I/O) unit 110 for conducting communication with external units in the communications system. In particular, the I/O unit 110 is adapted for receiving information, including identifier or address information and cell identifier, from the mobile units participating in a group-based communications session. The I/O unit 110 is also configured for receiving data, e.g. data packets, from the sending mobile unit and for transmitting this data to the receiving mobile units participating in the session.

The communications server 100 also comprises or is otherwise associated with and has access to a database 140 including information of the mobile units conducting the group-based communication of the invention. This database 140 is illustrated in FIG. 3. Firstly, the database 140 includes an identifier or address information (MS ID) 142 of the mobile units or stations (MS). This information element 142 could be any form of identifier as long as the communications server 100 is able to correctly identify the mobile unit and transmit data thereto based on the identifier 142. Typical examples of suitable identifiers could be Mobile Subscriber Integrated Services Digital Network (MSISDN), International Mobile Subscriber Identity (IMSI), Temporary Logical Link Identity (TLLI), Internet protocol (IP) address or email address.

The database 140 further preferably comprises session identifier or information (session ID) 144 identifying in which (group-based) data communications session(s) a mobile unit is participating. Thus, this session ID 144 enables the communications server 100 to identify those mobile units that are involved in a certain communications session. It is anticipated by the invention that a mobile unit simultaneously can participate in one or multiple communications sessions. In the latter case, the identifier 142 of the mobile unit is preferably entered once for each such session in the database 140 but then with different session identifiers 144 for the multiple communications sessions.

A cell identifier or information (cell ID) 146 is also provided in the database 140 for the mobile units. This cell ID 146 identifies a cell to which a mobile unit presently is connected or associated. Each mobile unit is preferably only associated with a single cell. In certain situations a mobile unit could actually be, at least temporarily, associated with two, or more, cells, e.g. during a handover procedure. However, a total time period of such a handover and, thus, the time period, during which a mobile unit is associated with multiple cells, is relatively short. Once the handover is completed, the mobile unit is anew connected to only a single cell and the identifier of this cell is then provided to and entered in the database 140. If multiple cells geographically overlap and a mobile unit is present in such an overlap area, the mobile unit is, though, preferably associated with the cell, the base station of which is providing the best radio link conditions. If the radio conditions would be equal for the equivalent cells the communications system should be able to force the mobile unit to only listen to just one of these cells and, thus, be associated only with one cell.

The mobile unit 142, session 144 and cell 146 identifiers are preferably associatively stored in the database 140. The expression “associatively storing” is referred to, in the present description, storing the identifiers 142-146 in such a way that it is possible to later find and possibly retrieve two identifiers, preferably the session 144 and cell 146 identifiers, based on knowledge of the remaining identifier, preferably the mobile unit identifier 142. A typical example of associatively storage is when the identifiers are stored together as a data entry in the database 140. Furthermore, the identifiers 142-146 may be stored at different locations within the database 140 or in different databases, as long as there is a connection, such as a pointer, between the different storage locations. This connection (pointer) enables the communications server to find the session 144 and cell 146 identifiers from the database 140 based on the mobile unit identifier 142.

Referring to both FIG. 1 and FIG. 3, the database 140 illustrated in FIG. 3 comprises information of the seven mobile units 400-430 participating in the communications session. The first entry in the database refers to the sending mobile unit 400 followed by the other two receiving mobile units 410, 412 situated in the same cell 15. These three mobile units 400-412, thus, have identical cell identifiers 146. Thereafter follows the mobile units 420-424 of the cell 25 and finally the single mobile unit 430 of the cell 35. Note that all the mobile units 400-430 have identical session identifiers 144 since they are presently members of a same group-based communications session.

Returning to FIGS. 2 and 3, the mobile unit 142 and cell 146 identifiers are preferably provided by the mobile units when they connect to the communications server 100. This connection could be performed once the mobile units are switched on and become connected to the communications system, during a session set-up or even during the actual communications session. If a mobile unit moves during the communications session into another cell, the mobile unit preferably transmits a cell update message to the communications server 100 informing the sever 100 of its new cell ID 146.

The communications server 100 further includes a database processor 130 that enters the identifiers and information received from the mobile units in the database 140. The processor 130 also updates the database once new information is received from a mobile unit, e.g. that the mobile unit has moved to a new cell (cell ID update), has entered a new communications session (new entry with MS ID, session ID and cell ID) or has left a session. The processor 130 preferably includes functionality for generating the session ID for the different communications sessions managed by the server 100. Once a communications session is ended, the processor 130 could delete the entries in the database 140 comprising the session ID of the ended session. This enables a re-use of the session identifiers. The processor 130 could also delete an entry for a mobile unit if it leaves a session but the remaining mobile units still participate in the session.

A mobile unit set or group identifier or identifying unit 120 is also provided in the communications server 100. This MS set identifier 120 is adapted for identifying, from the database 140, any sets of multiple (at least two) receiving mobile units having the same session and cell ID, i.e. participate in a same communications session and are situated in a same cell. The set identifier 120 is, thus, implemented for identifying a set of mobile units based on the cell ID and, preferably, on the session ID associated with the mobile units. Once the set identifier 120 finds such a set of receiving mobile units, the mobile units of the set is informed of a dedicated channel they all should lock and listen to. The communications data received by the I/O unit 110 and originating from the sending mobile unit is then transmitted to the identified mobile units forming the set using this notified same (common) channel.

The units 110, 120 and 130 of the communications server 100 may be provided as software, hardware or a combination thereof. The units 110, 120 and 130 and the database 140 may be implemented together in the server 100. The server 100 could be implemented in a network node of the communications system, e.g. in a multimedia subsystem frame of a communications network managed by a network operator. Alternatively, a distributed implementation is also possible with some units provided elsewhere in different network nodes in the communications network. Each communications network of a network operator could be equipped with a communications server 100 according to the present invention. Alternatively, multiple network operators could share and have access to a single communications server 100 managing group-based data communications for several different communications network and their associated mobile units.

The present invention will herebelow be described and disclosed in more detail with reference to a particular example of group-based data communications, namely PoC or IToC communication.

Briefly returning to FIG. 1, the communications system 1 provides PoC services to its associated PoC handsets or units 400-430. The system 1 could be a (mobile) cellular communications system, such as Global System for Mobile communications (GSM), General Packet Radio Service (GPRS), Enhanced GPRS (EGPRS), Enhanced Data rates for GSM Evolution (EDGE), Universal Mobile Telecommunications System (UMTS) or Code Division Multiple Access (CDMA) systems, such as Wideband CDMA (W-CDMA), CDMA 2000 and other CDMA systems.

The mobile units 400-430 comprises a PoC client implemented therein and are equipped with a PoC hardware or software button used for performing push to talk conversation. The users (owners) of the units 400-430 typically have a service agreement, e.g. subscription, with the PoC service provider (often the network operator). The mobile units 400-430 can be conventional mobile telephones configured with a PoC client. Alternatively, a mobile unit 400-430 could be a dedicated PoC handset, i.e. lacks traditional cellular mobile telephone functionalities, where the available communications services for the user are limited to PoC services, i.e. no “regular calls”.

The communications server 100 comprises a PoC application server that typically handles call set-up signaling for PoC calls and the flow control of PoC traffic. Furthermore, converting IMSI numbers to Internet Protocol (IP) numbers and real-time routing of IP packets carrying the bursty talk (audio) data to the correct receiving mobile unit 410-430 are managed by the PoC server. The server can also provide interface to the network operator's provisioning and network managing system and create charging detail records, used as a basis for billing of the PoC service. The PoC server preferably comprises, or has access to, a user database that stores information of e.g. provisioned users, their access rights, pre-configured group memberships and authentication information. The PoC server may viewed as a stand-alone equipment in the communications system 1. In such a case, the communications networks provided and managed by network operators may be connected to this PoC server. Alternatively, the PoC server may constitute a portion of a network operator's infrastructure. In this case, the PoC server may be implemented in an IP multimedia subsystem frame of each communication network.

The communications server 100 preferably also comprises a Multimedia Broadcasting Multicasting Service (MBMS) server. This server provides services similar to a database both for storage of multimedia content and also services similar to Home Location Register (HLR) where subscription information is stored. The benefit of this server is that it enables simultaneous distribution of data to several users using the same physical channel. This requires that the users log on to the server and register for a specific service with a certain content, e.g. football video clips at a game. For more information of MBMS reference is made to document [1].

By merging or having access to both a modified PoC server and modified MBMS server functionality, the communications server 100 can provide PoC service to the mobile units 400-430 and utilize the channel and communications resource saving benefits of the present invention. In other words, data packets comprising PoC voice data from the sending mobile unit 400 is transmitted to the sets of multiple receiving mobile units 410-412, 420-424 using a single communication channel per set.

As is known in the art of PoC, during the speech the talk is sampled, speech coded and packed into a number or data packets, typically Adaptive Multi Rate (AMR) packets or frames. These AMR packets are then often temporarily stored in a speech or transmitter buffer in the mobile unit 400. Before transmission to the receiving mobile units 410-430 over the radio communications system 1, the AMR packets or frames are packed into IP packets. The actual number of AMR packets per IP packet typically depends on the acceptable level of overhead, the used IP version and/or on header compression. Furthermore, Real-time Transport Protocol (RTP) is preferably used in the GPRS access and core network. The transmitted IP packets are then transmitted from the mobile station 400 through base station 10 to the PoC server of the communications server 100. The data packets are then eventually transmitted to the receiving mobile units 410-430.

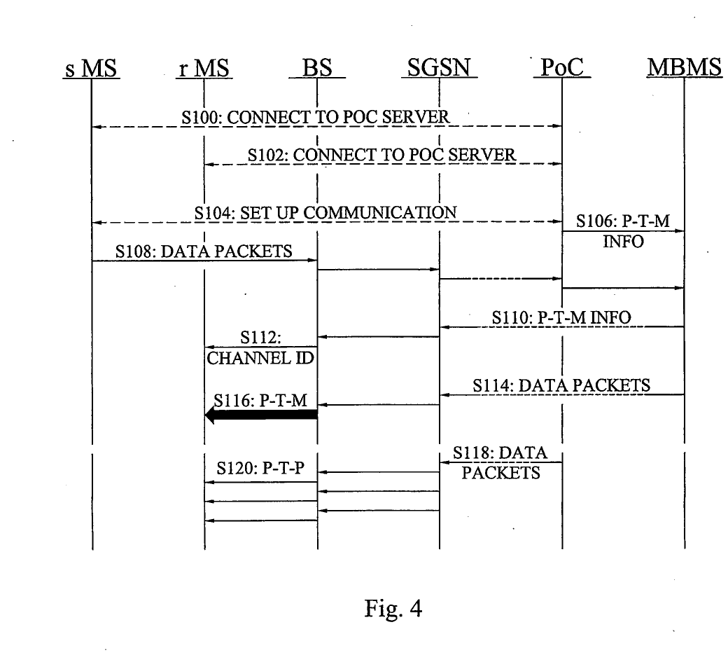

This data transfer and signaling is illustrated in more detail in FIG. 4. In this example, a sending PoC enabled mobile unit (s MS) wants to communicate with multiple receiving PoC enabled mobile units (r MS) situated in different cells. When the sending mobile unit is switched on or later connected to the PoC server it transmits its identifier, typically in form of IMSI or TLLI, together with information of the cell to which it presently is connected to the PoC server (S100). Correspondingly, the receiving mobile units preferably transmit their IMSI/TLLI and cell ID to the PoC server when they connect or register thereto e.g. in connection with being switched on (S102). Alternatively, the identifier and cell ID of the receiving mobile units could be provided to the PoC later during the session set up. The PoC server then updates an associated database with the received IMSI/TLLI, cell ID and generates or receives corresponding IP addresses used for PoC data packet transmission.

The user of the sending mobile unit then selects, e.g. in an address book or user list in the mobile unit, which receiving mobile units it wants to communicate with in the PoC session. Identifiers (IMSI, TLLI and/or IP addresses) of the selected receiving mobile units are transmitted to the PoC server during the PoC set up (S104). The PoC server updates its associated database by assigning a session ID or number for the mobile units to be participating in the PoC session, i.e. the sending mobile unit and the receiving mobile units.

The PoC server then identifies if there are multiple receiving mobile units in the PoC session that are situated in a same cell and, thus, forms a set of receiving mobile units according to the present invention. This set identification is preferably performed based on the previously generated session ID and received cell IDs. It could be possible that the PoC server for a given PoC session identifies no, one or multiple sets of mobile units. In the case no set is identified, the PoC communications is conducted according to prior art techniques, which is further discussed below. Alternatively, this set identification could be executed later in the PoC session e.g. in connection with the PoC sever receiving IP data packets from the sending mobile unit.

However, once at least one set according to the invention is identified the PoC server transmits information of the mobile units of the set to the MBMS server (S106). This information includes the IMSI/TLLI (MS ID) and cell ID, and possibly IP address, of the mobile units. The MBMS server enters this received information in an associated database and preferably generates a content or service code for the PoC data/session.

In the following description of FIG. 4, it is assured that the PoC server identifies a single set of receiving mobile units. However, in the case of multiple sets, the procedures for the other sets are equivalent to what is discussed.

The sending mobile station then transmits the (IP) data packets comprising the PoC voice data to the PoC server via its associated base station and other infrastructure units of the communications system, e.g. Serving GPRS Support Node (SGSN), Gateway GPRS Support Node (GGSN), etc., which is known to the person skilled in the art (S108). If a set of receiving mobile units was identified for the current communications session, the PoC server forwards the data packets to the MBMS server. The MBMS server transmits information to the SGSN, possibly through the GGSN node, required for realizing the point-to-multipoint data packet transmission of the invention (S110). This information includes the IMSI or TLLI of the receiving mobile units of the identified set. This information is used to inform these mobile units about the dedicated channel to which they should listen in order to receive the IP data packets originating from the sending PoC enabled mobile unit. The SGNS typically informs the base station controller associated with the cell of the set. The base station of the cell then preferably transmits a (1-bit) paging message to activate the receiving mobile units in its cell. The mobile units could then reply with a paging response message to the base station. A further message is then transmitted to the mobile units of the set informing them of which dedicated (downlink) channel they should lock and listen to (S112). When a base station receives an optional paging response message it notifies the MBMS server that the receiving mobile units of the set have obtained information of the channel they should lock to. The MBMS server then starts to transmit the data packets, originating from the sending mobile unit, to the base station to which the mobile units in the set are associated (S114). Alternatively, the MBMS server could be configured for starting to transmit the data packets after a predefined time interval from its transmission of the IMSI of the mobile units in the set (S110).

Once the base station receives the data packets it simultaneously transmits them using the previously notified dedicated channel to the multiple mobile units of the set (S116). This dedicated channel is preferably a Multimedia Receiver Channel (MMRC).

After the transmission of the data packets to the receiving mobile units, one of the receiving mobile units typically becomes a sending mobile unit. The turns to speak are typically granted by pressing the PoC button on a first come, first served basis. Thus, when the downlink data packet transfer phase is finished only one of the mobile units participating in the PoC session is allowed to set up a new uplink channel using channel required procedures and become sending mobile unit. This means that after the user of the sending mobile unit has talked and the users of the receiving mobile units have received and listened to the data any of the mobile units could be the sending mobile unit for next portion of the PoC session, or the session is ended. The PoC server then anew identifies if there is any set of receiving mobile units present. It could then be possible that a same set as previously is still active and/or that a new set of receiving mobile units is formed. For example, if mobile unit 430 of FIG. 1 becomes the sending mobile units and the remaining mobile units 400-424 are receiving mobile units, the set comprising mobile units 420-424 is identical as before whereas the other set now, in addition to mobile stations 410 and 412, also comprises the mobile station 400. No new transmission of information of the dedicated channel is required for the receiving mobile stations that already are locked to a dedicated channel of its associated cell and still are present in a set. However, if a new dedicated channel is to be employed or a mobile unit previously was not part of a set, a notification of channel ID is preferably transmitted to the unit(s).

Furthermore, the sending mobile unit is preferably assigned to the dedicated common channel for its associated cell during its transmission of data packets to the PoC server if such a channel exists for its cell. Thus, such channel notification could be sent through in-band signaling or e.g. by setting a downlink Temporary Block Flow (TBF) employing the existing uplink used for transmission of the IP data packets. When the uplink data packet transfer phase is finished, the mobile unit should move to the common dedicated channel for its cell to be ready to receive incoming data generated by another session participant.

It is also anticipated by the present invention that the sending mobile unit could be included in a set according to the invention. In other words, a set could include the sending mobile unit 400 of FIG. 1 in addition to the two receiving mobile units 410, 412 of the cell 15. However, since the sending mobile unit already has an assigned TBF it will not be affected by the notification and establishment of the dedicated common channel of this cell until its user stops talking and it becomes a receiving mobile unit.

If the PoC server does not identify any set of mobile units according to the present invention or for those single mobile units of a cell in the communications session, prior art techniques are employed for the data packet transmission. The PoC server then provides the data packets to the SGSN node that forwards them to the base stations of these single mobile units (S118). The data packets are then transmitted in a point-to-point manner to the single mobile unit(s) using one communication channel per mobile unit (S120).

When several mobile units of a set listens to a same channel according to the invention it may have an affect on the Link Quality Control (LQC). As is known in the art, for a high link quality, typically when a mobile unit is relative near a base station and the radio link conditions are good, a more aggressive coding scheme can be employed. However, for mobile units with a low link quality, typically positioned far from its associated base station and with poor radio conditions, a safer coding scheme is advantageously used. Since a set according to the invention includes at least two mobile units, their respective link quality could differ. In such a case, a relatively safe coding scheme could always be employed. Alternatively, the radio link quality of the mobile units in a set could be determined and then the mobile unit with the poorest radio link is identified. The measurement reports of this identified mobile unit is then used in LQC for all mobile units of the set.

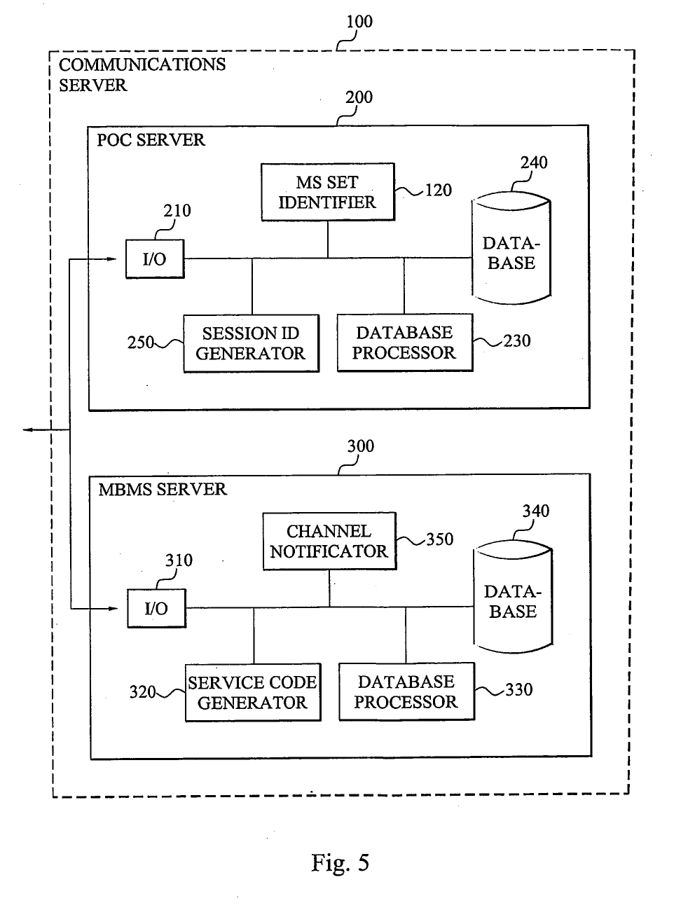

FIG. 5 illustrates a block diagram of a communications server 100 comprising a PoC server 200 and a MBMS server 300 according to the present invention. These two servers 200, 300 could be connected by logical or physical connections represented by the communication between respective I/O unit 210, 310 in the figure. Alternatively, the functionalities of the PoC 200 and MBMS 300 servers relevant for the present invention could be merged into a single communications server 100.

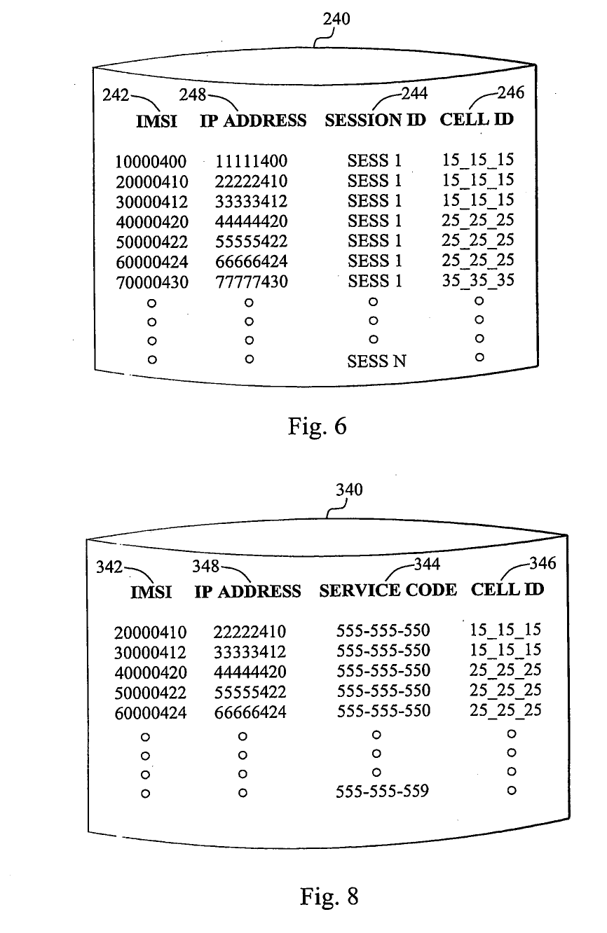

Starting with the PoC server 200, its I/O unit 210 is configured for conducting communication with the MBMS server 300 and external units in the communications system. The I/O unit 210 also receives IP data packets originating from a sending mobile unit and forwards them to the MBMS server 300 for further transmission to the mobile units that are members of a set and/or forwards the data packet directly, using the network infrastructure elements, to receiving mobile units not belonging to a set. The server 200 further comprises or is otherwise associated with a PoC database 240. This database 240 is illustrated in more detail in FIG. 6. The database 240 preferably comprises at least four data elements for each mobile unit connected or registered to the PoC server. These elements comprise IMSI, TLLI or another identifier 242 of the mobile unit, an associated IP address 248 of the unit, session identifier 244 and cell identifier 246, which was discussed above in connection with FIG. 3. These elements are preferably associatively stored in the database 240, e.g. as a data entry.

The PoC server 200 also includes a database processor 230 for managing the database 240. This processor 230, in particular, enters information (IMSI/TLLI and cell ID) received from mobile units through the I/O unit 210. This information reception preferably occurs during connection to the PoC server 200. The processor 230 also updates the information in the database 240 when such updatings are received, e.g. during session set up (Session Initiation Protocol (SIP) invitation) or SIP answers (SIP 200 OK). Once a PoC session is completed, the processor 230 preferably removes the data entries comprising this session ID from the database 240 in order to enable a re-use of the session ID for a subsequent PoC session.

A session ID generator 250 is arranged in the server 200 in order to generate session IDs for the PoC sessions managed by the server 200. This generator 250 is preferably configured for generating the session ID upon reception of information, from a sending mobile unit, identifying the receiving mobile units the sending unit wants to communicate with.

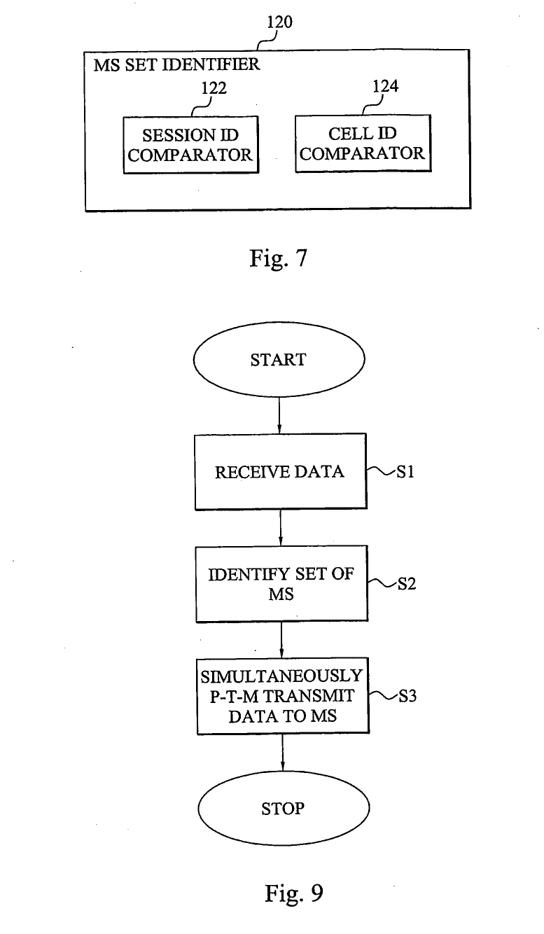

A mobile unit set identifier 120 is provided in the PoC server 200 for identifying those receiving mobile units of a PoC session that are present in a same cell and thus form a set according to the invention. This set identifier 120 preferably identifies any sets based on the session IDs and cell IDs stored in the database 240. FIG. 7 illustrates a preferred embodiment of the set identifier 120 comprising a session ID comparator 122 and a cell ID comparator 124. The session ID comparator 122 identifies all receiving mobile units of a given session ID. The comparator 122 could be configured for performing its identification functionality upon reception of information of the receiving mobile units from the sending mobile units during the session set up, and/or upon reception of the data packets from the sending mobile unit. This enables the comparator 122 to identify which mobile unit of a session that is the sending mobile unit. Alternatively, the database 240 could store, for each session ID, a notification of which mobile unit that currently is the sending mobile unit. Then the rest of the mobile units having a same session ID are regarded as receiving mobile units.

Once the session ID comparator 122 has identified the correct receiving mobile units it informs the cell ID comparator 124 of these, typically by providing their IMSI/TLLI or information of where their data elements are stored in the database. The cell ID comparator 124 then compares the cell IDs of the mobile units identified by the session ID comparator 122 in order to determine whether two or more mobile units have a same cell ID and, thus, form a set. The cell ID comparator 124 could then identify one, multiple or no set. If at least one set is identified, the cell ID comparator transmits by means of the I/O unit 210 information (IMSI/TLLI, cell ID and possibly IP address) of the mobile units in the set to the MBMS server.

Any charging for the service according to the present invention is preferably handled by the PoC server 200 since this server 200 knows which users that have accepted to participate in a PoC session and how much data that have been generated. In such a case, the PoC server 200 comprises functionality (not illustrated) used for generating charging basis data.

The MBMS server 300 in turn comprises an I/O unit 310 conducting communication with external units and the PoC server 200. Similarly to the PoC server 200, the MBMS server 300 comprises or has access to a database or Broadcast Multicast Service Center (BM-SC) 340. An example of such a database is illustrated in FIG. 8. According to the invention, this database comprises the IMSI/TLLI 342, IP address 348 and cell ID 346 received from the PoC server. In addition, the database 340 preferably comprises a service or content code 344 associated with the data packet contents that is to be provided to the mobile units, the IMSI 342 of which is associatively stored together with the service code 344. The database 340 typically includes other entries than those generated according to the invention. Thus, the database 340 may comprise information of mobile units to which the MBMS server provides traditional multimedia broadcast multicast services, e.g. video clips, financial news, etc. Each such different content is then preferably associated with a unique service code 344. For example, service code 555-555-550 refers to PoC session 1, service code 555-555-551 is associated with video clips from football match 1, financial news have service code 555-555-552, PoC session 2 has service code 555-555-553, etc.

A database processor 330 is implemented in the MBMS server 300 for entering data in the database 340, updating any data or removing data from the database 340. In particular, the processor 330 enters IMSI/TLLI and cell ID received from the PoC server through the I/O unit 330. A service code generator 320 generates the service codes for the database 340. A service code for a PoC session is preferably generated upon reception of the information of the mobile units of a set from the PoC server 200. The generator 320 could provide one service code for each set of mobile units entered in the database 340. Alternatively, a unique service code is generated for each content, e.g. data packets, and could then be applied to several sets of mobile units as long as they participate in the same session and, thus, should receive the same content (data packets). The codes are then provided to the processor 330 that enters them in the database 340. The processor 330 preferably also removes data entries form the database 340 once the MBMS server has delivered the required data (content).

A channel notificator 350 is provided in the MBMS server 300 for transmitting a message to the base station(s) associated with the mobile stations participating in a PoC session and the IMSI/TLLI of which is entered in the database 340. This message urges the base station(s) to inform its associated receiving mobile units of the PoC session of the dedicated channel they should lock and listen to.

The I/O unit 310 is then further implemented for receiving PoC data packets from the PoC server 200 and forwarding these data packets so that they are received by the mobile units having a service code in the database 340, which is associated with the received data packets. The I/O unit 310 transmits the data packets to the relevant base station(s), which in turn then forwards them using a respective dedicated channel to the mobile units being members in the set(s).

The units 120, 210, 230, 250, 310, 320, 330 and 350 of the PoC 200 and MBMS 300 servers may be provided as software, hardware or a combination thereof. The PoC server 200 could be implemented in a network node of the communications system, e.g. in a multimedia subsystem frame of a communications network managed by a network operator. Similarly, the MBMS server 300 could be implemented in a same or different network node. Alternatively, a distributed implementation is also possible with some units of the PoC server 200 and/or MBMS server 300 provided elsewhere in different network nodes in the communications network.

FIG. 9 is a flow diagram reviewing the data communication management method of the present invention. The method starts in step S1, where a communications server receives communications data originating from a sending user communications unit and intended to multiple receiving user communications units. The communications server then identifies a set of at least two receiving communications units that participate in the group-based communications session and are associated with a same cell in step S2. The server preferably identifies the communications units from an associated list or database including address information and cell identifiers of the communications units. In a next step S3, the data is simultaneously transmitted in a point-to-multipoint manner to the identified receiving user communications units of the set using a same dedicated (common) channel specific for the cell in which they are present. The method then ends.

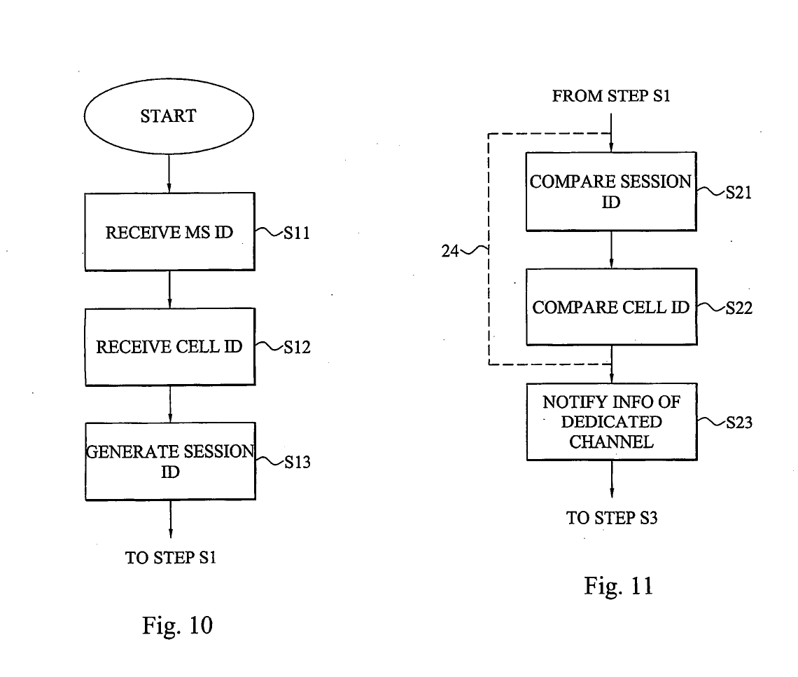

FIG. 10 illustrated additional steps of the method of FIG. 9. The method starts by the communications server receiving identifiers or address information of the communications units that are to participate in the communications session in step S11. The server also receives cell identifiers from these communications units in a next step S12. Thereafter, the communications server generates a session identifier for the communications units of the session in step S13 and stores this session identifier together with the cell identifier and address information in the associated database. The method then continues to step S1 of FIG. 9.

FIG. 11 is a flow diagram illustrating the set-identifying step of FIG. 9 in more detail. The method continues from step S1 of FIG. 9. In a next step S21, the communications server compares the session identifiers in its associated database and identifies those receiving user communications units that are associated with a first session identifier. Step S22 compares the cell identifiers of those communications units identified in the previous step S21. The communications server then identifies any communications units that have a same associated cell identifier and groups them into a set or sub-group. In this step S22, no, one or several sets of communications units could be identified. The steps S21 and S22 could optionally be repeated for all session identifiers in the database, schematically illustrated by the dashed line 24. In step S23, the identified receiving communications units of a set are notified information of a dedicated channel they should lock and listen to in order to receive the data originating from the sending user communications unit. If the communications units already are connected to this dedicated (downlink) channel no notification thereof is required and step S23 could be omitted. The method then continues to step S3 of FIG. 9.

It will be understood by a person skilled in the art that various modifications and changes may be made to the present invention without departure from the scope thereof, which is defined by the appended claims.

### REFERENCES

[1] 3GPP TS 43.246, version 0.8.0: 3^{rd} Generation Partnership Project; Technical Specification Group GSM/EDGE Radio Access Network; Multimedia Broadcast Multicast Service (MBMS) in the GERAN; stage 2 (Release 6), November 2003.

1. A method of performing data communication between a sending user communications unit and multiple receiving user communications units in a cellular communications system, comprising the steps of:
said sending user communications unit providing data to be communicated to said multiple receiving user communications units over said communications system;
identifying a set of at least two of said multiple receiving user communications units being associated with a same cell of said communications system; and
simultaneously transmitting said data to said identified receiving user communications units of said set using a dedicated channel specific for said cell.

2. The method according to claim 1, wherein said transmitting step comprises simultaneously point-to-multipoint communicating said data using said dedicated channel.

3. The method according to claim 1, wherein said communications system comprises a communications server managing said data communication, said method further comprising, for a user communications unit, the steps of:
generating, in said communications server, session data identifying a communications session, in which said user communications unit is participating; and
providing, to said communications server, cell information identifying a cell with which said user communications unit presently is associated.

4. The method according to claim 3, wherein said identifying step comprises identifying said set of receiving user communications units based on said session data and said cell information.

5. The method according to claim 4, wherein said identifying step comprises the steps of:
said communications server comparing, for a given session data, said cell information associated with said multiple receiving user communications units with a cell identifier of said cell;
identifying said set of receiving user communications units based on said comparison.

6. The method according to claim 3, further comprising, for a user communications unit, the steps of:
providing address information associated with said user communications unit to said communications server; and
associatively storing said address information, said session data and said cell information associated with said user communications unit in a database associated with said communications server.

7. The method according to claim 3, further comprising said user communications units providing said cell information to said communications server during a communications session set up procedure.

8. The method according to claim 1, further comprising providing a notification identifying said dedicated channel to said receiving user communications units of said set.

9. The method according to claim 1, further comprising point-to-point transmission of said data to receiving user communications units not belonging to said set using a single channel for each user communications unit.

10. The method according to claim 1, further comprising:
providing, for each receiving user communications units of said set, radio link quality information;
determining a lowest link quality based on said provided link quality information; and
using said lowest link quality for selecting coding scheme for all receiving user communications units of said set.

11. The method according to claim 1, wherein said dedicated channel is a multimedia receiver channel (MMRC).

12. The method according to claim 1, wherein said data communication is push to talk over cellular (PoC) communication.

13. A communications server adapted for managing data communication in a cellular communications system, said communications server comprising:
means for receiving data from a sending user communications unit and intended to be communicated to multiple receiving user communications units over said communications system;
means for identifying a set of at least two of said multiple receiving user communications units being associated with a same cell of said communications system; and
means for simultaneously transmitting said data to said identified receiving user communications units of said set using a dedicated channel specific for said cell.

14. The server according to claim 13, wherein said transmitting means is configured for simultaneously point-to-multipoint communicating said data using said dedicated channel.

15. The server according to claim 13, further comprising:
means for generating session data for a user communications unit, said session data identifying a communications session, in which said user communications unit is participating; and
means for receiving cell information identifying a cell with which said user communications unit presently is associated.

16. The server according to claim 15, wherein said identifying means is configured for identifying said set of receiving user communications units based on said generated session data and said provided cell information.

17. The server according to claim 16, wherein said identifying means comprises:
means for comparing, for a given session data, said cell information associated with said multiple receiving user communications units with a cell identifier of said cell; and
means for including a receiving user communications, the cell information of which corresponds to said cell identifier as determined by said comparing means, into said set of receiving user communications units.

18. The server according to claim 15, further comprising:
means for receiving address information associated with a user communications unit; and
means for associatively storing said address information, said session data and said cell information associated with said user communications unit in a database associated with said server.

19. The server according to claim 13, further comprising means for providing a notification identifying said dedicated channel to said receiving user communications units of said set.

20. The server according to claim 13, further comprising means for point-to-point transmission of said data to receiving user communications units not belonging to said set using a single channel for each user communications unit.

21. The server according to claim 13, further comprising a push to talk over cellular (PoC) server comprising said identifying means and a multimedia broadcasting multicasting service (MBMS) server comprising said transmitting means.

22. The server according to claim 21, wherein said MBMS server is configured for simultaneously transmitting said data using a multimedia receiver channel (MMRC).

23. A cellular communications system providing data communication between a sending user communications unit and multiple receiving user communications units, said system comprising a communications server according to claim 13.
